(19) United States
(12) Patent Application Publication
(10) Pub. No.: US 2017/0284667 A1
(43) Pub. Date: Oct. 5, 2017

(54) METHOD FOR REMOVING NITROGEN OXIDES FROM COMBUSTION FUMES WITH ON-SITE GENERATION OF AMMONIA

(71) Applicant: Casale SA, Lugano (CH)

(72) Inventors: Raffaele OSTUNI, Milano (IT); Federico ZARDI, Breganzona (CH)

(73) Assignee: Casale SA, Lugano (CH)

(21) Appl. No.: 15/631,739

(22) Filed: Jun. 23, 2017

Related U.S. Application Data
(63) Continuation of application No. 14/878,687, filed on Oct. 8, 2015, now abandoned.
Application No. 14/878,687 is a continuation of application No. 14/600,587, filed on Jan. 20, 2015, now abandoned.
Application No. 14/600,587 is a continuation of application No. 14/033,889, filed on Sep. 23, 2013, now abandoned.
Application No. 14/033,889 is a continuation of application No. 13/626,492, filed on Sep. 25, 2012, now abandoned.

(30) Foreign Application Priority Data
Nov. 2, 2011 (EP) 11187508.4

(51) Int. Cl. F23J 15/02; F23J 15/00; C25B 1/04; C01C 1/04; B01D 53/56; B01D 53/86

(52) U.S. Cl. CPC F23J 15/02; B01D 53/56; B01D 53/8631; C25B 1/04; C01C 1/04; F23J 15/006; B01D 2251/2062; F23J 2215/10; F23J 2219/10

(57) ABSTRACT

A method for the control of nitrogen oxides content in the combustion fumes of a thermal power plant is disclosed; the method comprises the on-site production of ammonia by the steps of: electrolysis of water as a source of hydrogen; separation of air as a source of nitrogen, formation of a make-up gas and synthesis of ammonia in a suitable synthesis loop; said on-site produced ammonia, or a solution thereof, is used for a process of reduction of nitrogen oxides in the combustion fumes.

### CROSS-REFERENCE TO RELATED APPLICATIONS

This application is a continuation of U.S. patent application Ser. No. 14/878,687, filed Oct. 8, 2015, which is a continuation of U.S. patent application Ser. No. 14/600,587, filed Jan. 20, 2015, which is a continuation of U.S. patent application Ser. No. 14/033,889, filed Sep. 23, 2013, which is a continuation of U.S. patent application Ser. No. 13/626,492, filed Sep. 25, 2012, which claims priority to European Patent Application No. 11187508.4, filed Nov. 2, 2011, the entire contents of which are incorporated herein by reference.

### FIELD OF THE INVENTION

The present invention relates to reduction of nitrogen oxides in the combustion fumes of a fixed installation.

### PRIOR ART

The combustion is still the source of most of the power generated in the world. One of the major environmental concerns in a thermal power plant is the formation of nitrogen oxides (NOx) during combustion. There are techniques for reducing the formation of NOx but a certain amount of said oxides in the flue gas is unavoidable and hence there is the need to remove nitrogen oxides from the flue gas stream. The same problem of NOx control arises with other fixed installations where a combustion takes place, like for example a waste incineration plant or a reformer or a fired heater. Hence any installation, and especially a large installation, using a process of combustion faces the problem of NOx control.

A known technique for removing nitrogen oxides from a flue gas is selective reduction, where nitrogen oxides are converted into nitrogen (N₂) and water, with the help of a reductant in an aqueous solution (ammonia water NH4OH or urea) or in a gaseous form (ammonia). The known art include selective non-catalytic reduction (SNCR) and selective catalytic reduction (SCR). The SNCR has been widely used in waste incineration plants and achieves a noticeable NOx reduction at higher temperatures, e.g. around 900 to 1000° C.; the SCR is often used in thermal power plants, for example steam or combined power plants, and is effective at a lower temperature around 400° C.

An installation comprising an SNCR or SCR equipment and using ammonia as the reductant, hence, consumes a certain amount of ammonia in order to remove NOx from the combustion flue gas.

This amount of ammonia is however a small amount in the current ammonia market. For example a large installation such as a 300 MW steam turbine power plant needs around 100 kg/h of ammonia for NOx removal. Nowadays ammonia is produced with large ammonia plants, where hydrogen is produced by steam reforming, and with a capacity of several hundreds of tons per day. The current tendency in the ammonia world is in favour of world scale plants delivering 1000-2000 tons/day and the so called mega-ammonia plants reaching 4000-5000 tons/day of ammonia. The reason is that the conventional, steam-reforming process needs several equipments including a primary reformer, secondary reformer, shift and CO2-removal for treatment of the reformed gas, etc. Hence the front-end is a large and expensive equipment, with a considerable capital cost, which incentives large plants with a high production rate. In particular, scaling to a capacity of around 1 ton/day (that is, the capacity required by a power plant of some hundreds of megawatts) is not economically viable.

Hence, operation of a power plant or other installation with an SNCR or SCR unit needs the purchase of this relatively small amount of ammonia, in a market which is governed by the production and exchange of much larger supplies. The cost for such small quantities of ammonia is high and volatile, and sometimes the availability of said small quantities is not sure.

### SUMMARY OF THE INVENTION

The aim of the invention is to overcome the above problem. More in detail, the problem underlying the invention is to find a more convenient way to control the nitrogen oxides in the combustion fumes of a fixed installation.

The term installation is used with reference to a plant, and industrial plant or a facility like e.g. a power plant. The invention can be applied to any fixed installation where a combustion takes place and nitrogen oxides are produced. A preferred application of the invention relates to control of nitrogen oxides in the fumes of a thermal power plant. A term thermal power plant is understood as a power plant for production of electric energy where the source of energy is the combustion of a fuel and then the problem of nitrogen oxides arises. Examples of thermal power plants to which the invention is applicable include fossil-fuelled and biomass-fuelled power plants, including also plants fuelled with solid waste or a waste-derived fuel. Other installations suitable for application of the invention include: waste incineration plants; reformers; fired heaters.

This problem is solved with a method for the control of nitrogen oxides in the combustion fumes, characterized by the on-site production of ammonia with electrolysis of water as a source of hydrogen, and separation of air as a source of nitrogen. The production of ammonia comprises the steps of: producing a hydrogen current by means of electrolysis of water; producing a nitrogen current by means of separation of nitrogen from air; forming an ammonia make up gas containing hydrogen and nitrogen from said hydrogen current and nitrogen current respectively, and reacting said make up gas at a suitable ammonia synthesis pressure. The ammonia, or a reductant obtained with said ammonia such as an aqueous solution thereof, is used for reduction of the nitrogen oxides contained in the combustion fumes.

The term on-site production of ammonia means that ammonia is produced directly in the site of the installation.

The above terms of hydrogen current and nitrogen current shall be intended as a hydrogen-rich and nitrogen-rich current, respectively. In particular the hydrogen current may contain some impurities and the nitrogen current may contain impurities and some oxygen.

The step of forming ammonia make up gas preferably comprise the steps of mixing together the hydrogen current and nitrogen current, compression to the ammonia synthesis pressure and purification. Said ammonia synthesis pressure is preferably in the range 80-300 bar.

The nitrogen current is preferably obtained by one of the following means: molecular sieves; pressure swing adsorption (PSA); vacuum pressure swing adsorption (VPSA); temperature swing adsorption (TSA); cryogenic separation.

The water electrolysis section need not be described since production of hydrogen by electrolysis is known. An electrolyser for production of hydrogen at a high pressure is describe for example in EP 2 180 087.

The water electrolysis section is powered with electric energy. Hence the production of hydrogen and, then, the production of ammonia with the on-site ammonia plant, will need some input of electric energy. Accordingly, a preferred feature of the invention is method is that the production rate of ammonia is regulated according to the cost and/or availability of electric energy. An excess of ammonia, compared to the actual need for removing NOx from the flue gas, can be stored in an appropriate tank or vessel.

When the referred installation is a thermal power plant, the water electrolysis will slightly reduce the net electric output of the plant. However, the ammonia can be produced and stored for subsequent use when the selling price of electricity is low, for example during night time. In some cases the price of electricity can be null, especially for a baseload power plant whose production is substantially constant and hence is in excess during the off-peak hours. The production of ammonia can be reduced or stopped, thus maximizing the net output of the plant, when the demand and price of electricity are higher.

Moreover, the energy consumption for hydrogen production is a small fraction (less than 1% and typically about 0.5%) of the output of the power plant. The overall consumption for the production of ammonia is typically less than 1% of the nominal output of the power plant. For example a 300 MW power plant needs about 100 kg/h of ammonia, which can be produced, according to the invention, with about 1 MW of electric power, namely 0.3%.

Hence the consumption of some electric energy is not a disadvantage, since energy is readily available at a low cost, especially during off-peak hours. On the other hand, the invention has the great advantage that the power plant is made independent from the ammonia market, being able to produce its own ammonia for the purpose of reduction of nitrogen oxides. Electric energy can be directed to ammonia production when the sale price of said energy would be lower or even null, thus producing ammonia at a very low cost or virtually at no cost.

The step of reduction of nitrogen oxides is preferably a selective catalytic reduction (SCR) but the invention is also applicable to installations using SNCR technique.

The term of removing nitrogen oxides means that nitrogen oxides are brought to a low concentration, depending on applicable regulations or contingent requirements. For example the nitrogen oxides can be removed to achieve a concentration of less than 100 mg/Nm³.

An aspect of the invention is also the modification of an installation, for example a thermal power plant, by addition of the above described on-site ammonia plant. Said installation comprises a selective reduction unit for removing nitrogen oxides contained in flue gas produced by combustion, by using ammonia or an ammonia-based reductant; the method of modification comprises the steps of: adding an on-site plant for the generation of ammonia, said ammonia plant comprising at least a water electrolysis section for production of a hydrogen current; an air separation unit for production of a nitrogen current from air; means to form an ammonia make up gas by mixing said hydrogen current and nitrogen current, and a high-pressure synthesis section for producing ammonia with said make-up gas.

The advantages of the invention will be elucidated with the help of the following description of preferred and non-limiting embodiments.

### BRIEF DESCRIPTION OF THE DRAWINGS

FIG. 1 is a block diagram showing a preferred embodiment of the invention.

### DETAILED DESCRIPTION OF PREFERRED EMBODIMENTS

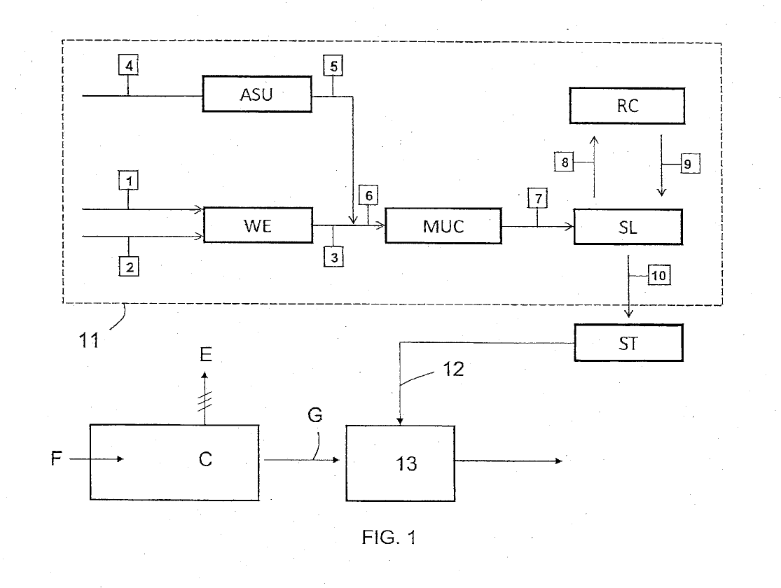

Referring to FIG. 1, the dotted boundary line 11 denotes an ammonia plant which is added on-site to a thermal power plant. The thermal power plant is generally denoted with block C and converts a fuel F into electric energy E. The stream G denotes combustion flue gas of said thermal power plant.

In this example the ammonia plant is added to a thermal power plant but in other applications of the invention, the ammonia plant 11 is added to other kinds of a fixed installation, where a combustion takes place and a flue gas is produced. Electric energy E may be produced or not in said installation.

Turning back to FIG. 1, the gas stream G could be, for example, the combustion fumes of a steam generator in a steam-turbine plant, or hot exhaust gas of a gas turbine or engine. Said stream G contains an amount of nitrogen oxides (NOx) formed during the combustion of the fuel F and which need to be removed, until an acceptable low concentration of NOx is reached.

The reduction of NOx takes place in a selective removal unit 13 and with the help of ammonia or an ammonia solution 12 produced in the on-site ammonia plant 11. In a preferred embodiment, in particular for a thermal power plant, said unit 13 is a SCR unit but a SNCR unit could also be used. For example, the hot combustion gases are first cooled in a heat exchanger, for example an economizer; they enter the SCR unit 13 around 350° C.; then the purified fumes are usually directed to a further heat recovery (e.g. preheating of combustion air) and/or they are treated (e.g. filtered) before release into atmosphere.

Said ammonia plant 11 comprises: a water electrolysis unit WE, an air separation unit ASU, a gas compressor MUC, a synthesis loop RL and a recycle compressor RC. The water electrolysis unit WE is fed with demineralised water 2 and electric power 1, and delivers a current 3 composed mainly of hydrogen. The ASU is fed with air 4 and produces a current 5 composed mainly of nitrogen.

The process of electrolysis of water, which takes place in the unit 1, is known in the art and need not be described. The nitrogen current 5 is preferably obtained with molecular sieves or with a process selected between pressure swing adsorption (PSA), vacuum pressure swing adsorption (VPSA) or temperature swing adsorption (TSA), or with cryogenic separation.

The hydrogen current 3 and nitrogen current 5 are mixed together and form a make-up gas 6. Said gas 6 is compressed to a synthesis pressure, preferably in the range 80 to 300 bar. The block MUC denotes the make-up gas compression and purification (removal of impurities) in order to obtain a compressed make-up gas 7 almost solely composed of hydrogen and nitrogen. The compressed gas 7 is sent to the synthesis loop SL; said loop SL is operating at said synthesis pressure, and comprises at least an ammonia reactor.

The product gas of said reactor contains ammonia and a certain amount of reagents (hydrogen and nitrogen). Ammonia is separated from said product gas and the remaining reagents are recycled to the reactor via a recycle compressor RC and currents 8, 9. In some embodiments, the recycle compressor RC is replaced by an additional stage of the gas compressor, namely the current 8 is sent to said additional stage of the compressor and returns into the loop SL via the stream 6.

The stream 10 is the ammonia product of the synthesis loop SL. Said ammonia product 10 is stored in a suitable storage vessel ST and is injected via the flow line 12 into the SCR unit 13. In some embodiments, the ammonia is stored in the form of an aqueous solution (ammonia-water).

The on-site ammonia plant 11 consumes a part of the energy E produced by the power plant, in particular for the production of the hydrogen current 3 in the water electrolysis unit WE. Hence, it may be stated that electric energy is basically the source of ammonia, provided that water 2 is available.

Preferably, the production of ammonia 10 follows the peaks of the demand of electricity. During off-peak hours ammonia can be produced in excess over the the amount necessary for the SCR unit 13, so that some ammonia is stored in the vessel ST; during peak hours, on the other hand, the production of ammonia is preferably reduced below the actual need of unit 13, or even stopped, in order to increase the net production of electricity; the ammonia stored in the vessel ST is then used to form at least part of the ammonia stream 12. In a more general way, the actual production of ammonia can be regulated according to the availability and/or cost of electric energy.

1. A method for the control of nitrogen oxides content in the combustion fumes (G) of a power plant for the production of electric energy where said combustion takes place, the method comprising the steps of:
producing ammonia in the site of said installation, with a process including: producing a hydrogen current by means of electrolysis of water; producing a nitrogen current by means of separation of nitrogen from air; forming an ammonia make up gas containing hydrogen and nitrogen from said hydrogen current and nitrogen current respectively, and reacting said make up gas at a suitable ammonia synthesis pressure; and
reducing nitrogen oxides contained in said combustion fumes using said produced ammonia;
wherein the production rate of ammonia is regulated according to the cost and/or availability of electric energy, and/or according to the load of said power plant and/or according to the demand of electric energy, such that the production of ammonia is increased during electricity off-peak hours when the demand for electricity is low, and is reduced or stopped, thus maximizing the net output of said plant, during electricity peak hours when the demand for electric energy is higher.

2. The method according to claim 1, said process of reducing nitrogen oxides being a process of selective catalytic reduction or selective non-catalytic reduction.

3. The method according to claim 1, said installation being any of: a thermal power plant for production of electricity, a waste incineration plant, a reformer, a fired heater.

4. The method according to claim 1, wherein said nitrogen current is obtained by one of the following means: molecular sieves; pressure swing adsorption (PSA); vacuum pressure swing adsorption (VPSA); temperature swing adsorption (TSA); cryogenic separation.

5. The method according to claim 1, wherein the synthesis pressure of ammonia is in the range 80 to 300 bar.

6. The process according to claim 1, where excess ammonia is produced during said electricity off-peak hours, or when production of ammonia is greater than actual need of the process for NOx reduction, and said excess ammonia is stored in a storage vessel (ST), either in anhydrous form or in the form of an aqueous solution.

7. A method for modification of an installation comprising a unit for reduction of nitrogen oxides from a combustion flue gas (G), wherein:
an on-site ammonia plant, for the generation of ammonia and for use in said reduction unit, is added to said installation,
said ammonia plant comprising at least: a water electrolysis section (WE) for production of a hydrogen current from water and electric energy; an air separation unit for production of a nitrogen current from air; means to form an ammonia make up gas by using said hydrogen current and nitrogen current, and an ammonia synthesis section (SL);
wherein said installation is a power plant for the production of electric energy and the production rate of ammonia is regulated according to the load of said power plant and/or according to the demand of electric energy, such that the production of ammonia is increased during electricity off-peak hours when the demand of electricity is low, and is reduced or stopped, thus maximizing the net output of said plant, during electricity peak hours when the demand of electric energy is higher.

8. The method according to claim 7, said installation being a thermal power plant for production of electricity.

9. The method according to claim 7, said unit for reduction of nitrogen oxides being a selective catalytic reduction or selective non-catalytic reduction unit.
